(19) United States
(12) Patent Application Publication
(10) Pub. No.: US 2018/0254033 A1
(43) Pub. Date: Sep. 6, 2018

(54) Smart Noise Reduction System and Method for Reducing Noise

(71) Applicant: DAVI AUDIO, LONGWOOD, FL (US)

(72) Inventors: Leonard Davi, Longwood, FL (US); William Moseley, Rodessa, LA (US); Demian Martin, San Leandro, CA (US)

(21) Appl. No.: 15/800,654

(22) Filed: Nov. 1, 2017

Related U.S. Application Data
(60) Provisional application No. 62/416,138, filed on Nov. 1, 2016.

(51) Int. Cl. G10K 11/178; G10L 25/18

(52) U.S. Cl. CPC G10K 11/17823; G10K 2210/3011; G10K 2210/1081; G10L 25/18

(57) ABSTRACT

A system and method for reducing noise in a headphone compares the ambient sounds in a particular location to a plurality of noise reduction settings that are stored in a storage medium. The best noise reduction settings are then used to reduce noise.

### BACKGROUND

Noise cancelling headphone today, pro, con

a. Active noise reduction has been used in headphones for over 20 years with success. It works to reduce ambient noise and make for a less stressful experience. Feedback and feedforward techniques as well as hybrid techniques have been used with good success and are the best current techniques.

b. However noise environment are not all the same and different noise qualities need different methods for getting the best subjective results.

### SUMMARY

a. Noise is not uniform so noise reduction needs to be optimized for specific tasks and locations.
Noise can be random or “stationary” (hums and buzzes). Not all noise has the same spectrum, some has more midrange energy and some more low frequency energy.
The active noise reduction can be optimized for different scenarios and noise types but one optimization will not necessarily give the best subjective results in all cases. Especially if the headphone is reproducing music at the same time.

b. Our invention is a means for optimizing noise reduction for specific locations or specific noise environments.

c. It can be a manual selection or an automatic selection
Several manual options can be provided or a system for automatic selection is proposed.

### BRIEF DESCRIPTION OF THE DRAWINGS

FIG. 1 is a depiction of the current noise canceling system using headphones and circuits:

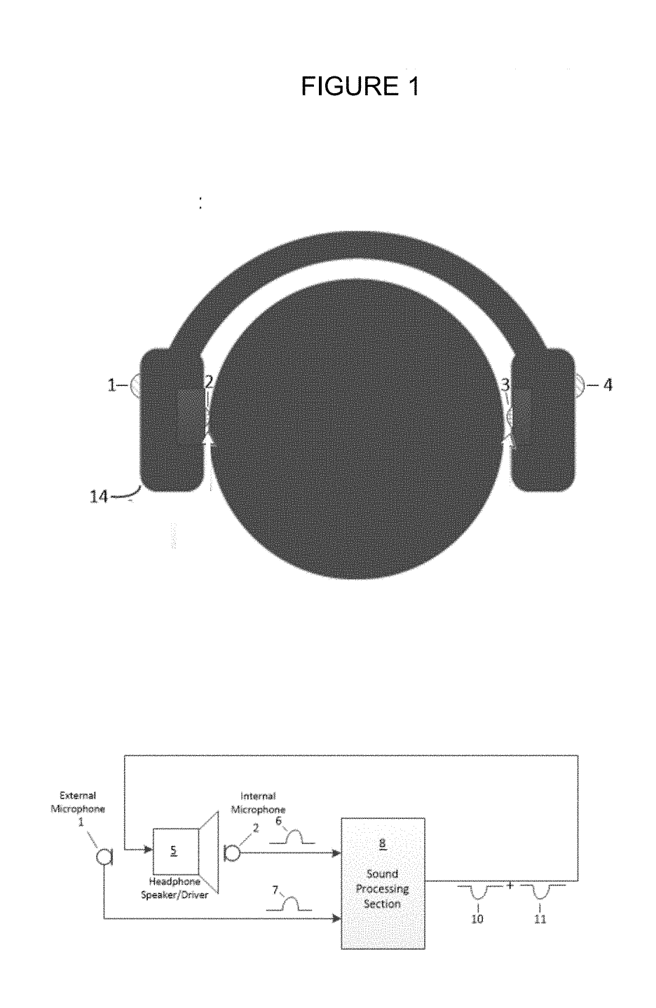

FIG. 2. illustrates the noise spectrum for a variety of modes of transportation.

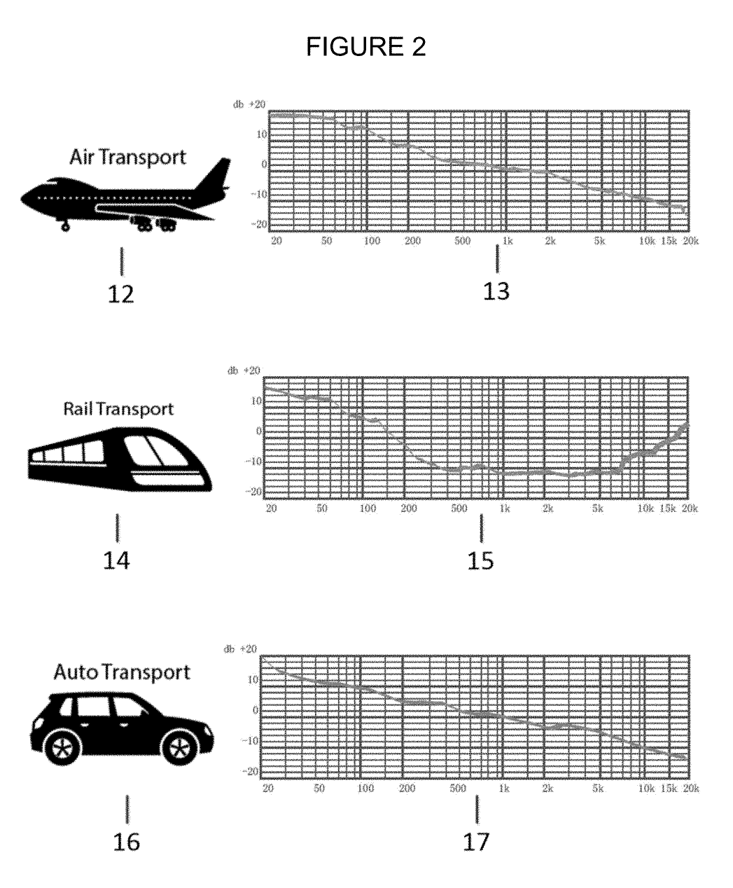

FIG. 3 depicts existing and the desired noise reduction performance;

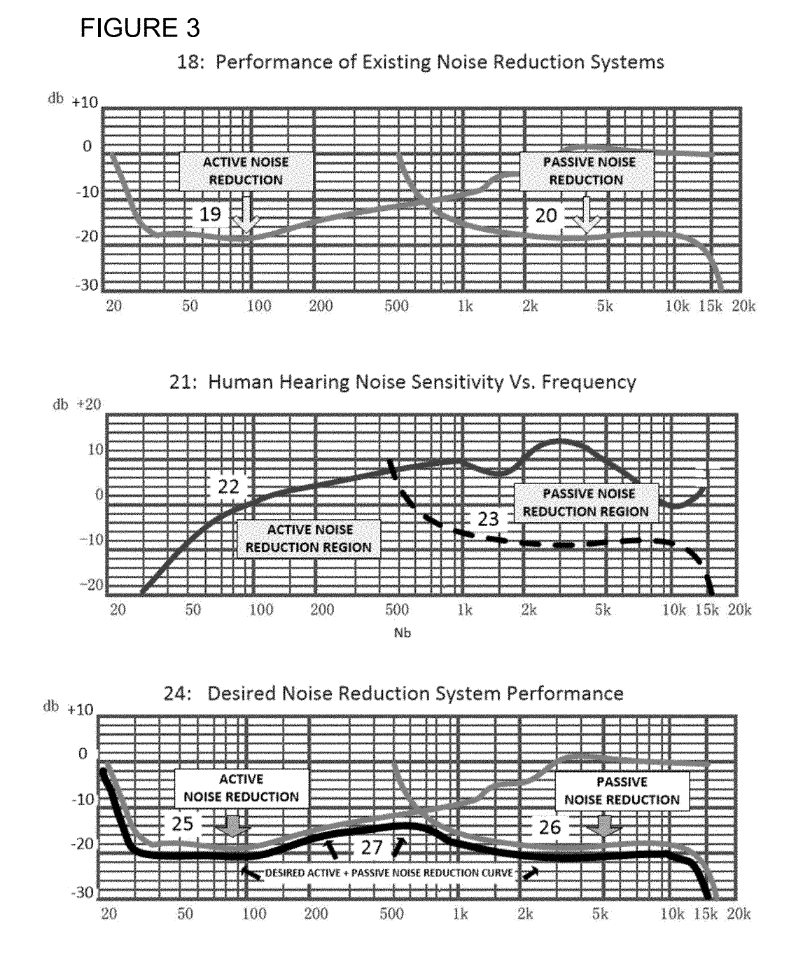

FIG. 4 depicts one embodiment of an automatic noise reduction system according to the present invention; and

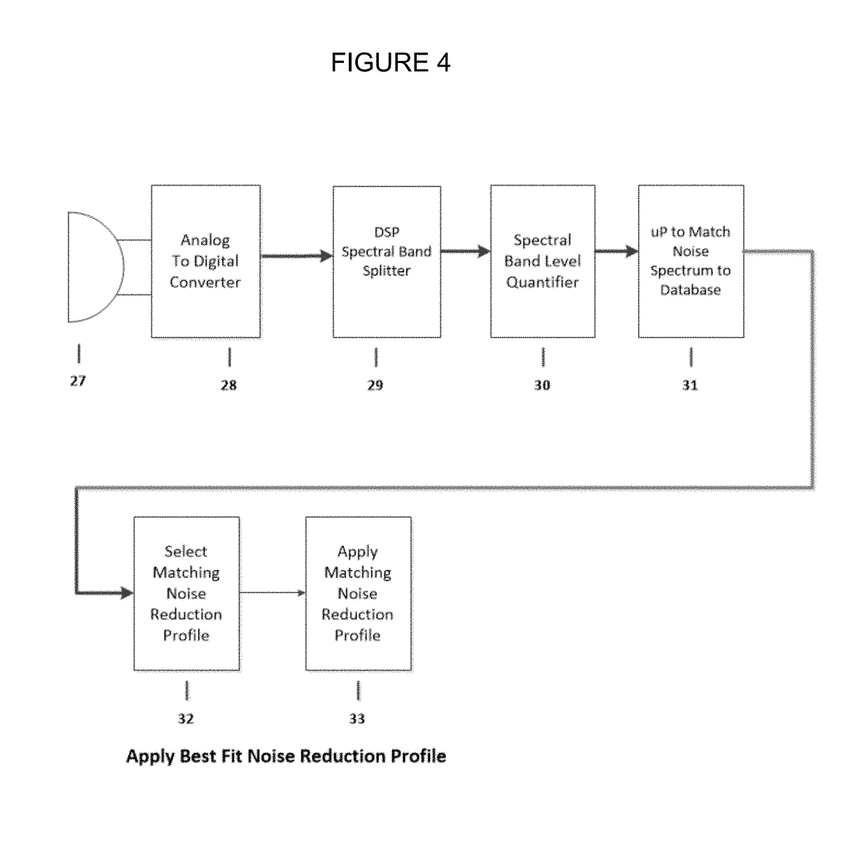

FIG. 5 depicts the areas of one mode of transportation that could send noise canceling profiles from a system in the transportation to the receiving apparatus like headphones.

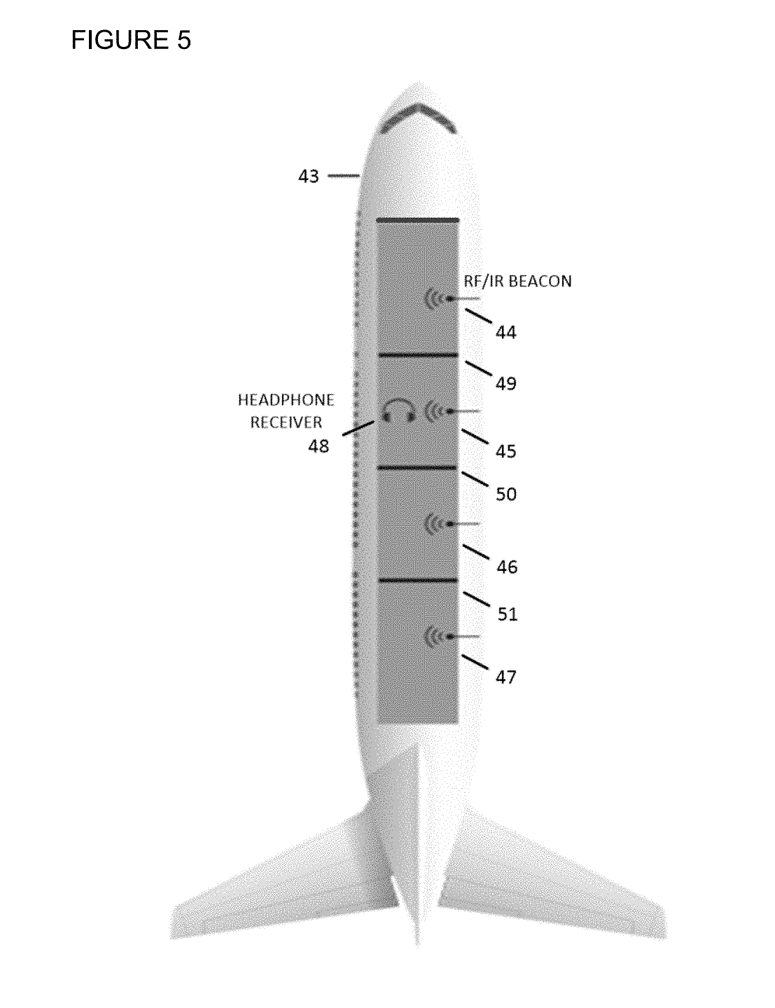

### DETAILED DESCRIPTION

Optimized noise reduction can't be determined through a “mechanical” fully auto-adaptive means. Manual individual optimization is needed because the perceptual elements involved are complex and subjective. There are many factors that influence the perception of level and annoyance of noise and they do not lend themselves to a simple algorithm for optimum noise reduction. Testing and optimization of the noise cancelling will need to be done with both trained listeners and general subjects to get the most broadly applicable results.

A set of optimized noise reduction settings for the noise reduction system created by the process in #3, we will call “profiles”, can be stored in the headphone or downloaded to it from external devices as needed through bluetooth connection, USB connections and store it in a writable medium in the headphones.

Various targets' environmental noise would be captured and used to optimize the “profile” for that specific noise. These would be stored in a database that they would be referenced for selecting the optimum “profile”.

For best results the actual target environment would need to be characterized and the process used to optimize a profile for that specific target.

The headphone can contain a collection of profiles it can select internally on the headphone or
a. They can be downloaded from an app on a mobile device
b. For automatic selection
   For an automatic system the nature of the ambient noise needs to be identified. Spectral analysis and matching can be used to identify the nature and spectral distribution of the noise
   Then match the signature to the table of previously created optimized solutions, “profiles” of feedforward and feedback noise cancelling settings, that will give the best perceived experience which will be loaded into the noise reduction system.

The noise signature identification can be done using hardware and software in the headphone or
a. It can be done using an app on a mobile device or
b. It can be manually selected by the user from a set stored in the headphone or in an app.

If it's done in the headphone the noise pickup for spectrum recognition can be from the internal feedforward microphones (if present) or a voice pickup microphone

Radio or IR beacon recognition to select optimized noise reduction
a. In some environments, airplanes and trains for example, the ambient noise can be different in different locations. Radio or IR beacons in the various locations can be detected and trigger specific pre-created optimized ambient noise reduction profiles best suited to the locations.
b. These same beacons could transmit specific data triggering other changes if the ambient sound is expected to change (e.g. coming to a stop for a train, or take-off or landing of a plane).
c. It's also possible for the beacon to provide specific noise profiles for its location that are compatible with the headphone that the headphone can download. This relieves the need for the headphone to have all profiles already stored.
d. This system can also work with the beacons receiving data transmitted from the device and passing that data to a host processor which could use the beacons bi-directionally or a separate communications system could also be transmitting to the devices. This could be used to reduce the number of separate communications systems needed in some applications.

The beacons can be used for other purposes as well for example:

Bluetooth Low Energy link to host environment for device location, recognition, inventory and noise reduction profile update.
a. The same wireless or IR link can be used to maintain an inventory of the headphones in use in a location and where in the location the headphone may be found if configured for bidirectional communications.
b. The wireless link can be used to send notifications to the specific headphone wearer without broadcasting the notification to other users or announcing to all people in the space.
c. The link can be used to keep track of the status of headphones including info such as battery charge, current listening status etc.
d. The link can be used as a theft prevention feature to deactivate the headphone if removed from the location.

Existing Noise Cancellation
a. External microphone (1&4) and internal microphone (2&3) pickup sound (represented electrically by waveform 6 and 7). The external microphone's sounds are amplified filtered and delayed in the sound processing section (8) to match the sound leaking through the housing (14) and inverted (10 & 11) and fed to driver (5) to generate a sound equal and opposite to the sound leaking into the headphone.

Noise Spectra
a. Different environments will have different spectra, An airplane (12) will have a broad relatively flat spectrum (13), A train (14) might have a lot of low frequency noise and high frequency noise (15) and a car (16) might have a lot of low frequency noise (17)

Existing and Desired Noise Reduction Performance
a. Existing practice will get a lot of noise reduction across a narrow band (19) but that band typically is in a region of lower hearing sensitivity (21 & 22). Passive noise reduction (20, 23, 26) will reduce high frequency noise above 1 KHz or so but is not effective in low frequencies.
b. Desired noise reduction (24) should match hearing sensitivity (equal loudness curves) to noise in a way that does not call attention to noise components that otherwise would be benign. The active noise reduction (25) performance would be tailored to get the optimum match (27) to hearing sensitivity and perceived annoyance level

ANC Selection System
a. Microphone (27) picks up the ambient noise and passes the signal to A to D converter (28) (which may be in the same circuitry or IC as the other electronic elements described) which digitizes the audio and passes it to a digital signal processor element (29) that separates the signal into frequency bands which are then quantified (30) and the quantified information is passed to a processor (31) that matches the description of the sound to a database to select (32) the best noise reduction settings which are then loaded into the noise reduction system (33)

Headphone/Device Location
a. In confined environments (building, airplane or train car) (43) different spaces are illuminated with infrared or radio frequency beacons (44,45,46,47) that headphone (48) can receive and act upon including loading a different noise reduction profile.
b. Limited range or physical barriers (48,49,50,51) control which beacon the headphone (48) can receive at a specific location enabling location identification.

We claim:

1. A system for canceling ambient noise comprising:
a storage medium having a plurality of noise reduction settings;
a processor for receiving ambient noise in a particular location and comparing the ambient noise level to the noise reduction settings;
a receiver for receiving the noise reduction settings to cancel the ambient noise in the particular location.

2. A method of canceling ambient noise in a particular location comprising the steps of:
recording and storing a plurality of noise reduction profiles;
sampling ambient noise in particular location;
separating the ambient noise into frequency bands;
comparing the frequency bands of the sampled ambient noise and to the stored plurality of noise reduction profiles and selecting one of the plurality of noise reduction profiles to use.
